(19) United States
(12) Patent Application Publication
(10) Pub. No.: US 2023/0123123 A1
(43) Pub. Date: Apr. 20, 2023

(54) VIBRATION ATTENUATION DEVICE AND RESONATOR

(71) Applicant: Qatar Foundation for Education, Science and Community Development, Doha (QA)

(72) Inventors: Sami El-Borgi, Doha (QA); Ralston Fernandes, Doha (QA); Rawad Yazbeck, Doha (QA); James Boyd, Doha (QA); Dimitiers Lagoudas, Doha (QA); Karim Bellila, Doha (QA)

(21) Appl. No.: 17/966,049

(22) Filed: Oct. 14, 2022

Related U.S. Application Data
(60) Provisional application No. 63/255,612, filed on Oct. 14, 2021.

(51) Int. Cl. F16L 55/033; G10K 11/172

(52) U.S. Cl. CPC F16L 55/0333; G10K 11/172

(57) ABSTRACT

A vibration attenuation device is provided. The vibration attenuation device includes one or more connectors configured to be attached to a primary structure, a plurality of beams mounted on the one or more connectors, and a plurality of weight materials attached to the beams. The primary structure comprises at least one of a pipe, a rod or a shaft.

### CROSS REFERENCE TO RELATED APPLICATION

The present application claims priority to U.S. Provisional Patent Application No. 63/255,612, filed Oct. 14, 2021, the disclosure of which is incorporated into this specification by reference in its entirety.

### BACKGROUND

Piping systems are integral and ubiquitous components in both on-shore and offshore oil and gas process industries. As a consequence of increased operational limits, these piping systems can become more susceptible to vibration induced fatigue failures. These vibration-induced fatigue failures may arise due to flow-induced vibration, vortex-induced vibration, acoustic-induced vibration and shell transverse acoustic vibration. These vibrations are detrimental to piping systems and their associated components such as pressure relief valves, flow control valves, elbows, T-joints etc. Thus, piping failures can result in disastrous economic and environmental consequences.

Flow induced vibration (FIV) or vortex shedding is a result of residual vortices generated due to high flow velocities of fluids/gases across dead leg branches in the piping network. At specific frequencies, the fluid/gas flow excites acoustic resonance, producing high pulsations and thereby undesirable vibrations. Vortex Induced Vibration (VIV) can produce fatigue in the pipelines which in turn can lead to cyclic damage of the pipelines. Acoustic Induced Vibration (AIV) is commonly observed in pipelines used in the oil and gas industry which can result in high frequency acoustic energy that can be developed through the pressure reducing device such as a flow control valve, relief valve, orifice plate etc. Shell Transverse Acoustic (STA) vibration resonance occurs when the transversal acoustical waves traveling through the pipe match the shell mode natural frequency of the pipe. Thus, there are needs to develop effective and efficient vibration attenuation devices that are capable of reducing and/or minimizing the vibration issues of the piping systems.

### SUMMARY

The present disclosure generally relates to a vibration attenuation device and a resonator for suppressing vibrations in piping systems.

In light of the present disclosure, and without limiting the scope of the disclosure in any way, in an aspect of the present disclosure, which may be combined with any other aspect listed herein unless specified otherwise, a vibration attenuation device is provided. The vibration attenuation device includes one or more connectors configured to be attached to a primary structure, a plurality of beams mounted on the one or more connectors, and a plurality of weight materials attached to the beams.

In an aspect of the present disclosure, which may be combined with any other aspect listed herein unless specified otherwise, the primary structure comprises at least one of a pipe, a rod or a shaft.

In an aspect of the present disclosure, which may be combined with any other aspect listed herein unless specified otherwise, the one or more connectors comprise a pair of semi-rings.

In an aspect of the present disclosure, which may be combined with any other aspect listed herein unless specified otherwise, the pair of semi-rings is connected to each other through a fastener to form a ring shape.

In an aspect of the present disclosure, which may be combined with any other aspect listed herein unless specified otherwise, each of the beams includes a first end attached to the one or more connectors and a second end opposite to the first end. The plurality of weight materials are attached to the second end of the beams.

In an aspect of the present disclosure, which may be combined with any other aspect listed herein unless specified otherwise, the vibration attenuation device comprises four or more beams.

In an aspect of the present disclosure, which may be combined with any other aspect listed herein unless specified otherwise, the vibration attenuation device is configured to vibrate at frequencies in approximate to frequencies of the primary structure.

In an aspect of the present disclosure, which may be combined with any other aspect listed herein unless specified otherwise, the vibration attenuation device is configured to create a bandgap to the primary structure.

In an aspect of the present disclosure, which may be combined with any other aspect listed herein unless specified otherwise, the bandgap is a frequency region, and vibrations are attenuated in the frequency region.

In light of the present disclosure, and without limiting the scope of the disclosure in any way, in an aspect of the present disclosure, which may be combined with any other aspect listed herein unless specified otherwise, a resonator for suppressing vibration in a piping system is provided. The resonator includes one or more connectors configured to be attached to a pipe, a plurality of beams mounted on the one or more connectors, and a plurality of weight materials attached to the beams.

In an aspect of the present disclosure, which may be combined with any other aspect listed herein unless specified otherwise, the resonator is a three dimensional resonator.

In an aspect of the present disclosure, which may be combined with any other aspect listed herein unless specified otherwise, the resonator has a symmetric shape.

In an aspect of the present disclosure, which may be combined with any other aspect listed herein unless specified otherwise, the one or more connectors comprises a pair of semi-rings.

In an aspect of the present disclosure, which may be combined with any other aspect listed herein unless specified otherwise, the pair of semi-rings is connected to each other through a fastener to form a ring shape.

In an aspect of the present disclosure, which may be combined with any other aspect listed herein unless specified otherwise, the resonator comprises two or more beams.

In an aspect of the present disclosure, which may be combined with any other aspect listed herein unless specified otherwise, the resonator is configured to vibrate at frequencies in approximate to frequencies of the primary structure.

In an aspect of the present disclosure, which may be combined with any other aspect listed herein unless specified otherwise, the resonator is configured to form a bandgap to the pipe, and the bandgap is a frequency region, and vibrations of the pipe are attenuated in the frequency region.

The reader will appreciate the foregoing details, as well as others, upon considering the following detailed description of certain non-limiting embodiments including a vibration attenuation device and a resonator for suppressing vibrations in piping systems.

### BRIEF DESCRIPTION OF THE DRAWINGS

Features and advantages of a vibration attenuation device and a resonator for suppressing vibrations in piping systems described herein may be better understood by reference to the accompanying drawings in which:

FIG. 1 is a schematic illustration of a vibration attenuation device or a resonator according to an embodiment of the present disclosure.

FIG. 2 is a schematic illustration of a vibration attenuation device or a resonator according to an embodiment of the present disclosure.

FIGS. 3A-3D illustrate an experimental vibration setup (test rig) of a piping system. FIG. 3A is a front view of the experimental vibration setup; FIG. 3B is a side view of the experimental vibration setup; FIG. 3C is a rear view of the experimental vibration setup; and FIG. 3D is a close-up view of data acquisition system, PC and shaker according to an embodiment of the present disclosure.

FIG. 4 is a schematic illustration of locations of accelerometer measurement points in the test rig. (dimensions in mm and measurements points numbered from 1 to 13).

FIG. 5 is a schematic diagram of numerical and experimental natural frequencies of a scaled piping system according to an embodiment of the present disclosure.

FIGS. 6A-6C are schematic illustrations of measured mode (solid line) and computed mode (dot line) shape pairing in an Finite Element (FE) model.

FIG. 7A is a schematic illustration of location of measurement and excitation on an FE model of piping with resonators according to an embodiment of the present disclosure; FIG. 7B is a schematic illustration of location of the attached resonators. (dimensions in millimeters; the light gray symbol * indicates the location of the node where the harmonic load was applied and the dark gray symbol * represents the node where the response was computed).

FIGS. 8A-8C are schematic diagrams of simulations of bandgap formation for the first three modes of vibration of the piping system with attached resonators according to an embodiment of the present disclosure. The area shaded in gray represents the formed bandgap. FIG. 8A is a schematic diagram of simulation of bandgap formation for mode 1 of vibration of the piping system with attached resonators; FIG. 8B is a schematic diagram of simulation of bandgap formation for mode 2 of vibration of the piping system with attached resonators; and FIG. 8C is a schematic diagram of simulation of bandgap formation for mode 3 of vibration of the piping system with attached resonators.

FIG. 9A illustrates a side view of an example of a fabricated vibration attenuation device or resonator according to an embodiment of the present disclosure; and FIG. 9B illustrates a top view of the example of the fabricated vibration attenuation device or resonator.

FIGS. 10A-10C are schematic diagrams of experimental validation of bandgap formation for the first three modes of vibration of the piping system with embedded resonators according to an embodiment of the present disclosure. The area shaded in gray represents the formed bandgap. FIG. 10A is a schematic diagram of experimental validation of bandgap formation for mode 1 of vibration of the piping system with attached resonators; FIG. 10B is a schematic diagram of experimental validation of bandgap formation for mode 2 of vibration of the piping system with attached resonators; and FIG. 10C is a schematic diagram of experimental validation of bandgap formation for mode 3 of vibration of the piping system with attached resonators.

The reader will appreciate the foregoing details, as well as others, upon considering the following detailed description of certain non-limiting embodiments of the present disclosure.

### DETAILED DESCRIPTION

The present disclosure generally relates to a vibration attenuation device and a resonator for suppressing vibrations in piping systems.

The embodiments are described more fully herein after with reference to the accompanying drawings, in which some, but not all embodiments of the present technology are shown. Indeed, the present technology may be embodied in many different forms and should not be construed as limited to the embodiments set forth herein.

Likewise, many modifications and other embodiments of the vibration attenuation device and resonator for suppressing vibrations in piping systems described herein will come to mind to one of skill in the art to which the invention pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

Throughout the specification and claims, terms may have nuanced meanings suggested or implied in context beyond an explicitly stated meaning. Likewise, the phrase “in an embodiment” as used herein does not necessarily refer to the same embodiment or implementation and the phrase “in another embodiment” as used herein does not necessarily refer to a different embodiment or implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context. In addition, the terms “about,” “around” “approximately” and “substantially” are understood to refer to numbers in a range of numerals, for example the range of −10% to +10% of the referenced number, preferably −5% to +5% of the referenced number, more preferably −1% to +1% of the referenced number, most preferably −0.1% to +0.1% of the referenced number.

The terminology used herein is for the purpose of describing particular exemplary embodiments only and is not intended to be limiting. The terms “comprise”, “comprises”, “comprised” or “comprising”, “including” or “having” and the like in the present specification and claims are used in an inclusive sense, that is to specify the presence of the stated features but not preclude the presence of additional or further features.

When an element, component or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Piping systems are essential elements in both onshore and offshore oil and gas facilities. These piping systems are prone to vibration induced fatigue failure as a result of excessive operation. These vibration-induced fatigue failures include acoustic-induced vibration, flow induced vibration, vortex induced vibration etc. The aforementioned vibrations not only damage the piping system, but also they can result in detrimental damages to its associated components such as pressure relief valves, flow control valves, T-joints etc.

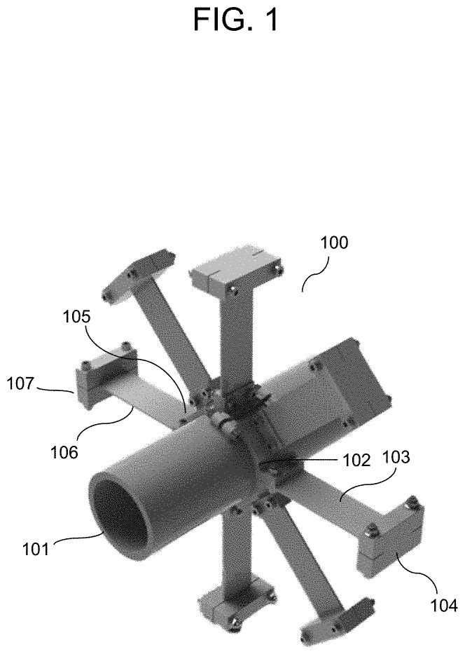

According to an embodiment of the present disclosure, a vibration attenuation device is developed. As illustrated in FIG. 1, the vibration attenuation device 100 may include one or more connectors (e.g., 102 and 105) configured to be attached to a primary structure 101, a plurality of beams (e.g., 103 and 106) mounted on the one or more connectors (e.g., 102 and 105), and a plurality of weight materials (e.g., 104 and 107) attached to the beams (e.g., 103 and 106). In some examples, the primary structure 101 may be at least one of a pipe, a rod or a shaft. The vibration attenuation device 100 may have a symmetric shape in some examples.

In some examples, the one or more connectors may be a pair of semi-rings, semi-squares, semi-rectangles or other desirable shapes. The pair of semi-rings may be connected to each other through a fastener (e.g., threaded nuts) to form a ring shape. The pair of semi-squares may be connected to each other through a fastener (e.g., threaded nuts) to form a square shape. The pair of semi-rectangles may be connected to each other through a fastener (e.g., threaded nuts) to form a rectangular shape.

In some examples, the connectors (e.g., 102 and 105) may include more than three pieces and connected to each other to form a desirable shape such as a ring, a square or rectangle. In other examples, the connector may be made with a single piece (e.g., single connector in a ring shape or other desirable shapes). In this case, the single piece connector may be attached to the primary structure 101 during the manufacturing process of the primary structure 101.

In some examples, each of the beams (e.g., 103 and 106) may be a flexible thin beam. Each of the beams (e.g., 103 and 106) may include a first end attached to the one or more connectors (e.g., 102 and 105) and a second end opposite to the first end. As illustrated in FIG. 1, each of the connectors (e.g., 102 and 105) has three beams mounted on the connector. In other examples, each of the connectors may have one or more beams mounted on the respective connector. The plurality of weight materials (e.g., 104 and 107) may be attached to the second end of the beams (e.g., 104 and 107). In other examples, the weight materials may be disposed on any other suitable position along the length of the beams (e.g., middle part of the beams). The shape of the weight materials (e.g., 104 and 107) may have a rectangular, circle or square shapes. In some examples, the shape of the weight materials may have other desirable shape as well.

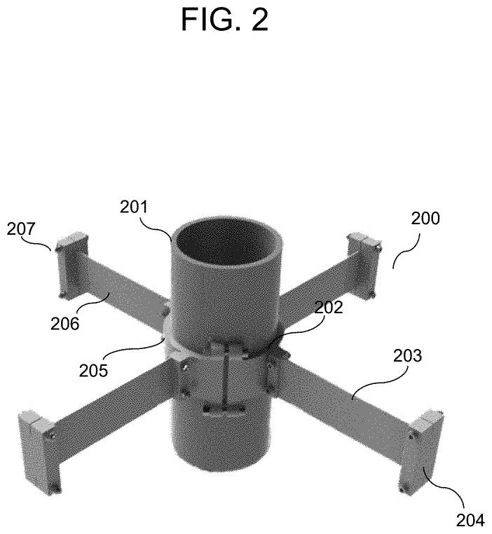

According to an embodiment of the present disclosure, another vibration attenuation device is developed. As illustrated in FIG. 2, the vibration attenuation device 200 may have similar connectors, beams and weight materials to the vibration attenuation device 100 as illustrated in FIG. 1. For example, the vibration attenuation device 200 has a first connector 202 and a second connector 205. Each of the connectors (e.g., 202 and 205) has two beams mounted on the connector. In other examples, each of the connectors may have one or more beams mounted on the respective connector.

According to an embodiment of the present disclosure, a three dimensional device is provided. The three dimensional device may attenuate vibration of structures. For example, it can be attached to primary structures such as pipes, rods and shafts. The vibration attenuation devices as illustrated in FIGS. 1 and 2 are non-limiting examples of the three dimensional device. The vibration attenuation device may be also called a resonator because it may vibrate at frequencies in proximately to the resonant frequencies of the primary structure. The placement of several devices on the primary structure may allow passive vibration attenuation and bandgap formation along modes that act in one of three directions, or any combination of the three directions. A bandgap is a frequency region where vibrations are attenuated and mechanical waves cannot propagate.

The three dimensional device may be an assembly made of two semi-rings that can be connected together to which six beam type resonators can be mounted and masses attached at the tip of the beams. The whole assembly may act as a three dimensional resonator that can attenuate vibration passively and create bandgaps in a system with circular geometries, such as piping systems, rods, and shafts.

Piping systems may have three-dimensional structures and possess modes of vibration along three directions (e.g., x, y and z directions). The configuration and design of the three dimensional device can suppress vibrations simultaneously along one, two or three directions (e.g., x, y and z directions). The design of the three dimensional device according to the present disclosure uses beam-type resonators rather than mass-spring systems/discrete systems, and creates multiple bandgaps (e.g., two, or three, or more) at different frequencies ranges, simultaneously, in several directions rather than just a single bandgap in a single direction. In some examples, aspects of the present disclosure may provide a three dimensional device that is capable of vibrating along three directions (e.g., x, y and z directions) in addition to providing the means to tune the resonators so that the bandgap is located at a specific location.

In some examples, trial and error may be needed to tune the resonators due to uncertainties affiliated with the material properties and boundary conditions. The tuning process in the design of the three dimensional device according to the present disclosure may be much simpler (e.g., e.g., simply cutting beams, thereby saving time) than ones required by the convention system (e.g., requiring a fabrication of a new connection material, thereby increasing the overall cost and time).

In some examples, the three dimensional device according to the present disclosure may be made with Computerized Numerical Control (“CNC”) machined steel beams, blocks, sheets, and shafts. In particular, a three dimensional device according to the present disclosure may be made with two steel semi-rings, six thin steel beams, and six steel rectangular masses as illustrated in FIG. 1. In other example, a three dimensional device according to the present disclosure may be made with two steel semi-rings, four thin steel beams, and four steel rectangular masses as illustrated in FIG. 2. The three dimensional device according to the present disclosure may be fabricated using 3-axis rotation CNC machines or 5-axis rotation CNC machining. The beam-type resonators may be cut from a steel sheet and the masses (e.g., weight materials) can be made, using CNC machining, of steel beams or steel blocks.

In some examples, the three dimensional device can be used by oil and gas transportation industries to help attenuate detrimental vibration in pipes that transport fluids. The three dimensional device according to the present disclosure can be connected to pipes easily and inexpensively.

According to an embodiment of the present disclosure, a resonator assembly is provided. The resonator assembly according to the present disclosure may include two semi-rings that can be connected together (e.g., via threaded nuts), multiple (e.g., 4 or 6 or more) flexible thin beams mounted on the semi-rings, and multiple (e.g., 4 or 6 or more) masses attached at the tip of the beams. The resonators can be fabricated using 3-axis or 5-axis rotation CNC machines. The whole assembly may act as a three dimensional resonator that can attenuate vibration passively and create bandgaps in a system composed of circular geometries such as piping systems, rods and shafts. The dimensions of the beam-type resonator as well as the masses of the resonator may be parameters needed to effectively create a bandgap at desired frequencies. The resonator device according to the present disclosure may be inexpensive and can be easily fabricated. The resonator can be used by oil and gas transportation industries to help attenuate detrimental vibration in pipes that transport fluids.

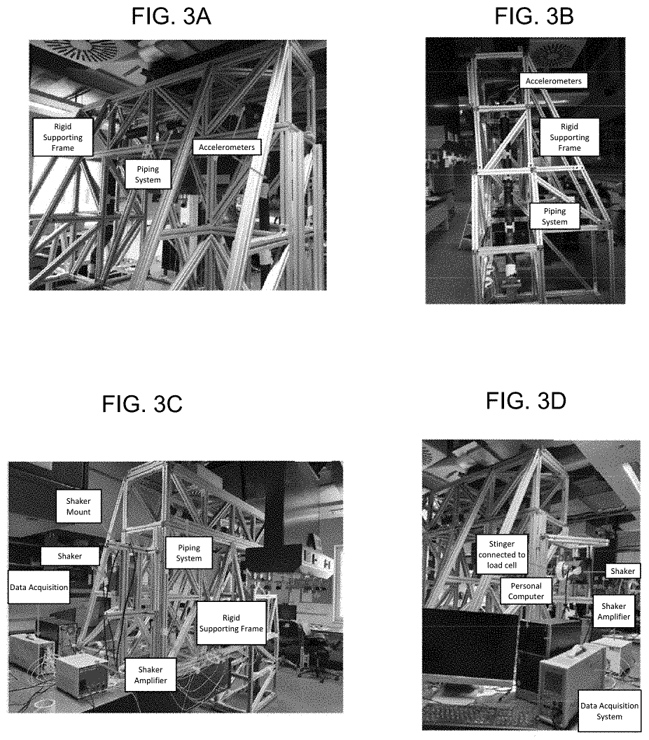

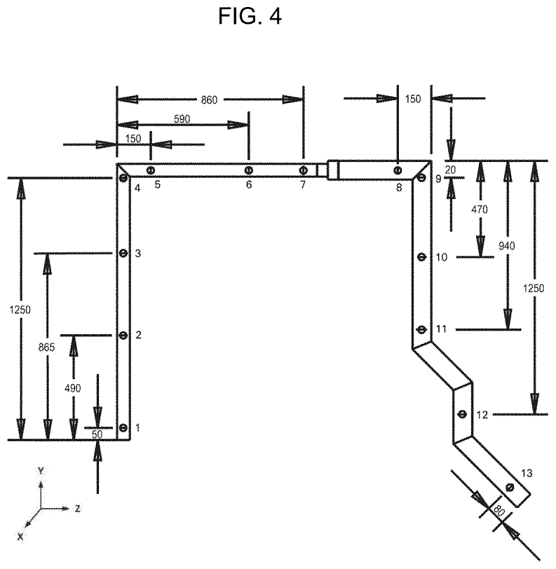

According to an embodiment of the present disclosure, a test rig was constructed to conduct free and forced vibration tests on the scaled-down piping system to extract the natural frequencies and their corresponding mode shapes. The test setup may include the piping system coupled with one or more vibration attenuation devices, a personal computer with a data acquisition (DAQ) system, an analyzing software, a set of accelerometers, an impact hammer and an electromagnetic shaker. Different views of the vibration test setup are illustrated in FIGS. 3A to 3D. A total of 13 accelerometers were attached to the structure on 13 measurement points indicated by symbols in FIG. 4. It is worth noting that for the vertical members, the accelerations were measured along the x and z directions at each of the measurement points 1, 2, 3, 4, 9, 10, 11, 12 and 13. For the horizontal member, the accelerations were measured along the x, y and z directions at each of the measurement points numbered 5 to 8. This would enable the measurements of all possible and realistic motions of the structure.

The DAQ system may include a personal computer connected to DataPhysics ABACUS analyzer DP700-30-16C4S with 16 input channels and 2 output channels along with SignalCalc analyzing software and Vector II control software. A total of 15 accelerometers were employed in these experiments of the type PCB single axis general purpose ceramic shear ICP 10 mV/g weighing each 8 gms. To conduct the impact test, a PCB general purpose modal analysis impact hammer with 8 kHz frequency range, 500 lb amplitude range, 10 mV/lb sensitivity, 0.3 lb hammer mass and 0.6 inch head diameter was utilized. To perform the forced vibration test, a DataPhysics SignalForce GW-V20 electromagnetic shaker was also employed along with its power amplifier GW-PA-100E in addition to a 074-290A 300 mm long stinger, which was used for dynamically decoupling the shaker from the structure. The force applied by the shaker on the metamaterial beam is measured using a multi-purpose, ICP force sensor, 100 lb in both compression and tension load cell attached to the stinger, as shown in FIG. 3D.

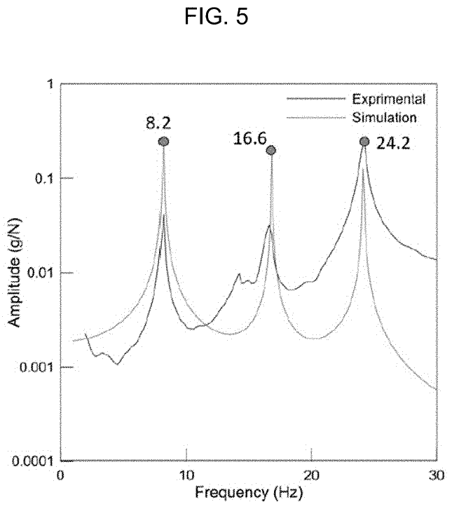

The dynamic behavior of the piping system was investigated and the first three modes of vibration along with their respective resonant frequencies were obtained numerically and validated experimentally. FIG. 5 is an example of a frequency response function that illustrates the amplitude of the piping system versus frequency. Peaks in the frequency response function correspond to resonant frequencies of the piping system. FIG. 5 indicates that the numerical results of the first three resonant frequencies (8.2 Hz, 16.6 Hz and 24.2 Hz) of the piping system are in close agreement with the experimental results. In the even that pipe operates close to these resonant frequencies, significant damage may occur and there is a need to develop technologies that mitigate these large amplitude vibrations.

According to an embodiment, vibration attenuation at these resonant frequencies was accomplished by designing and attaching resonant elements (e.g., resonators) along the length of the piping system. The purpose of these resonant elements (e.g., resonators) is to create a frequency range (e.g., bandgap) that spans on or more of these resonant frequencies in which the vibration attenuation of the pipe is significantly attenuated. An illustration of one of these resonators that can be attached along the length of the piping structure and that can suppress vibrations occurring along the x, y or z direction or any combination of those three directions is illustrated in FIG. 1. As illustrated in FIG. 1, the segment of the pipe is modeled as a hollow shaft. The assembly of the three dimensional (3D) resonator is a combination of two semi-circular rings, attached to each other via threaded nuts. The rings serve as a mechanism to couple the flexible beams with the masses at the tips to the shaft. The dimensions of the beam type resonator as well as the mass of the resonator are parameters needed to effectively create a bandgap at desired frequencies.

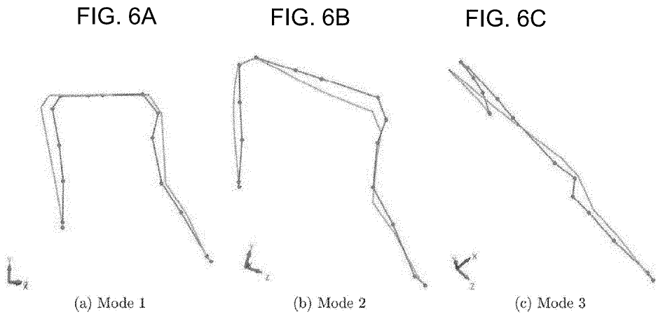

While the three dimensional (3D) resonator can suppress vibration in these three directions (e.g., x, y or z direction), the experimental results of the piping system discussed above demonstrated vibration modes only along the x and z directions. This is shown using experimental measurements as well as from computational models (e.g., an updated Finite Element (FE) model) as depicted in FIGS. 6A-6C.

There are many uncertainties encountered when developing an FE model. The sources of uncertainty range from material properties to boundary conditions in addition to other factors such as meshing and applied loads. These sources of uncertainty can be considered as parameters of the FE model that can be adjusted based on realistic engineering assumptions. FE model updating consists of updating these parameters in an attempt to minimize the error between the predicted and the measured response. Therefore, the objective of FE model updating is to obtain a reasonable correlation between experimental and numerical modal properties for the purpose of obtaining a relatively faithful computational model that can replicate the actual behavior of the structure.

Updating is based on a sensitivity analysis of the FE model stiffness matrix with respect to the selected parameters. Then a nonlinear iterative algorithm is used to compute the values of the updating parameters until the error between the FE and experimental response is minimized. The error can be based on the following: (a) comparison between computed and measured frequencies; and/or (b) comparison between computed and measured mode shapes. The comparison between the frequencies can be estimated using the relative error between the computed and measured frequencies and the comparison between the corresponding detailed and reduced order mode shapes can be performed. Iterations are continued until the computed errors satisfy a certain convergence criterion.

The basic formulation of FE updating can be briefly summarized as follows. Model updating is based on the following matrix equation:

{ΔR}=[S]{ΔP} (1)

where {ΔP}={P}−{P⁰} in which {P} is a vector containing various parameters of the numerical model and {P⁰} is a vector containing the starting values of the parameters. The vector {ΔR}=R^{e}−{R} represents the change in response in which {R} is a vector containing responses from the model such as frequencies and mode shapes and {R^{e}} is a vector associated with the reference response test data. The matrix [S] appearing in the above equation is the sensitivity matrix containing gradients of the responses R with respect to the parameters P which is given by

$$[ S ] = {S}_{i j} = \frac{\partial {R}_{i}}{\partial {P}_{j}} \qquad ( 2 )$$

The updated values of parameters P are obtained from Eqs (10 and (2) as follows:

{P}={P⁰}+[G]({R^{e}}−{R}) (3)

where [G] is the gain matrix computed following Bayesian estimation theory as

[G]=[C_{P}][S]^{T}([C_{R}]+[S][C_{P}][S]^{T})⁻¹ (4)

in which [C_{P}] is a weighting matrix that expresses the analyst's confidence in {P^{o}} and the reference responses test data {R^{e}}.

The measured and computed mode shapes after updating for the three detected modes are shown, respectively, in FIGS. 6A to 6C. It is worth noting that a relatively small correspondence is observed between the third and first experimental and FE mode shapes respectively. This correspondence is due to the fact that both mode shapes are acting along a similar direction (x-direction) and, therefore, a small similarity between the modes is observed. However, the correspondence is small and can be neglected which indicates that there is almost a one to one correspondence between the experimental and the computed mode shapes. Therefore, it can be stated that the error between the updated and the experimental vibration modes was minimized due to model updating.

According to an embodiment of the present disclosure, a 3D resonator with a total of four beams is provided. As illustrated in FIG. 2, the 3D resonator has four beams where two beams along the x-direction and two beams along the z-direction. The following design methodology was adopted to determine the appropriate dimensions of the beam type resonator as well as the value of the masses attached to their tips. Prior to fabricating the 3D resonators, numerical simulations were performed to test whether this design methodology could effectively attenuate the vibration amplitude at desired frequencies.

According to an embodiment of the present disclosure, tuned resonant elements (3D resonators) are attached along the length of the piping system for the purpose of vibration attenuation through bandgap formation. The bandgap formation is simulated by performing a harmonic response analysis (HRA) using the finite element software FEMTOOLS. When the HRA is performed, the steady-state response of the piping system is calculated over a range of frequencies in response to a specified excitation of the structure. The bandgap formation is characterized by a significant attenuation of the amplitude of the targeted resonant frequency of the piping system where no resonant frequencies of the metastructure are observed. In addition, two new resonant peaks around the targeted frequency are observed. The resonators are designed to vibrate in the x- and z-directions since the first three dominant modes of vibration of the piping system are limited to those directions. The first and second modes of vibration are flexural modes occurring in the x and z directions, respectively, while the third mode is a torsional mode around y with motion along the z direction.

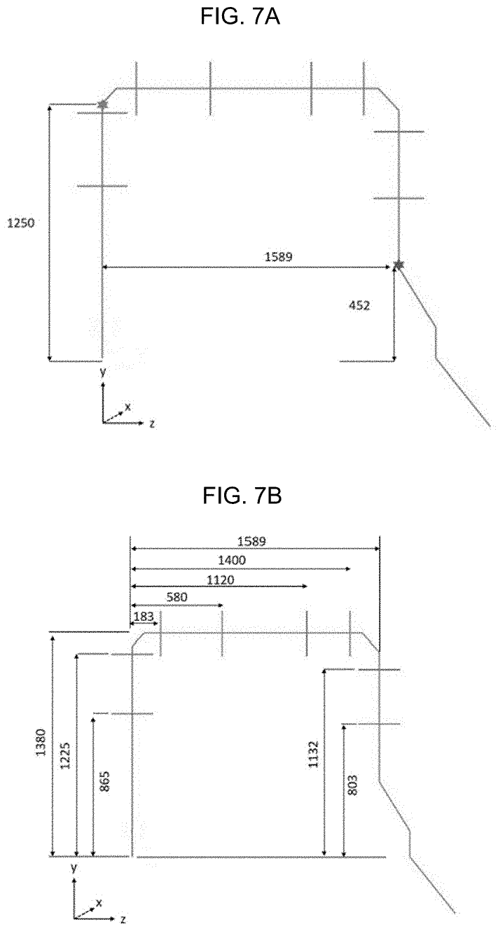

The double cantilever beam resonator dimensions are obtained for a specified mass ratio μ=0.2, and number of resonators S=8. In the current simulation, it is assumed that the beam resonators are fabricated from steel with modulus of elasticity E_{b}=200 GPa and density P_{b}=7849 kg/m³. Table 1 lists the design specifications of the steel beam resonators tuned to the first three modes of vibration. The harmonic excitation and response measuring locations are depicted in FIG. 7A. The locations of the resonators along the length of the piping system are shown in FIG. 7B.

TABLE 1
Specifications of steel beam resonators
tuned to the first three modes.

| | Length | Width | Thickness | |
|---|---|---|---|---|
| | a_{b} | w_{b} | t_{b} | Mass |
| Mode | (mm) | (mm) | (mm) | M_{b} |
| 1 | 135 | 27 | 1.4 | 0.55 |
| 2 | 86 | 27 | 1.4 | 0.55 |
| 3 | 68 | 27 | 1.4 | 0.55 |

For these numerical simulations, as well as for the experimental tests, the first parameter to be determined is the number of resonators to be distributed along the length of the piping system. For the purpose of the experimental validation of the 3D resonator on a scaled industrial piping system, eight attachments with two symmetric beam resonators on either end, leading to N=16 as shown in FIG. 7B.

The next parameter is the ratio of all the masses of the resonators to the mass of the piping system, referred to as p. If the mass of each beam type resonator is m_{R}, then,

$$μ = \frac{N {m}_{R}}{{M}_{p i p e}}$$

The computational work has demonstrated that the bandgap width increases with the value of μ. For this proof of concept, μ=0.2. Having chosen the value of N and knowing the mass of the piping system, the mass of each individual beam type resonator m_{R}, can thus be determined.

The next step in the design of the resonator requires the choice of the resonant frequency of the piping system at which a bandgap is desired to be created. This frequency is also referred to as the center frequency (f). The choice of the center frequency of the bandgap also dictates the natural frequency of the beam type resonator. For finite flexural metamaterials, this relation is given by

$${ω}_{R} = \frac{2 f}{1 + \sqrt{1 + μ}}$$

Once the resonator frequency ω_{R} is known and the mass ratio μ is chosen, the stiffness of the resonator, k_{R} can be determined by the following equation.

k_{R}=ω_{R}²m_{R}

It is noted that beam type resonators are continuous structures and as such, have an infinite number of resonant frequencies. The proof of concept exploits the only the first and fundamental natural frequency of a cantilevered beam type resonator with a proof mass. The discussion on the resonator design until this point did include dimensions of the beam type resonator. In order to determine these dimensions, the beam type resonator is modeled as an equivalent single-degree of freedom system whose effective stiffness k_{eff}, and effective mass, m_{eff}, may match the values of k_{R} and m_{R} respectively. These terms can be expressed as

$${k}_{e f f} = \frac{3 EI}{{L}^{3}}$$

$${m}_{e f f} = 0.24 ρ A L + M$$

Where E is the modulus of elasticity and ρ is the density of the material used to create the beam type resonator. I is the moment of inertia of the beam. For a beam with a rectangular cross-section, I=bh³/12, where b is the width of the beam and h is its thickness. L is the free length of the beam type resonator and M is the value of the proof mass. For a given material, careful optimization of the dimensions of the beam as well as the proof mass results in the values of k_{eff}, and, m_{eff} that match the values of k_{R} and m_{R} respectively.

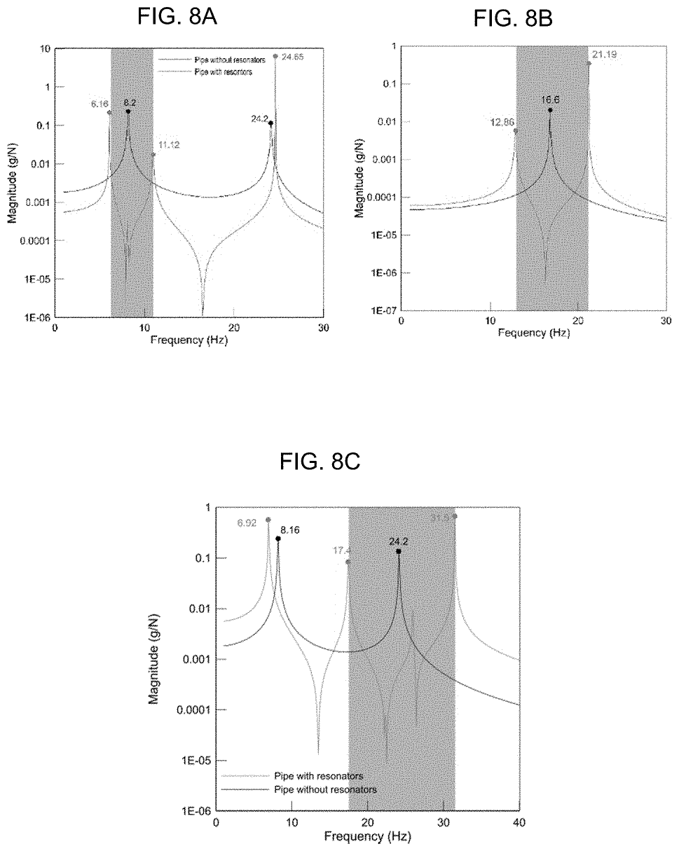

In the frequency response functions (FRFs), the bandgap is characterized by a dramatic reduction in the vibration amplitude at the frequency of interest as well as the frequency range in which no resonant frequencies of the system exist. Simulations were performed and the ability of these resonators to create bandgaps at the desired frequencies was demonstrated for the first three modes of vibration as depicted in FIGS. 8A-8C. The bandgap formation is evident for the first three modes of vibration since the resonant frequencies of the primary structure clearly show an attenuation in the amplitude, in addition to the creation of new resonant frequencies around the targeted frequency. It is worth mentioning that for modes 1 and 3, which occur along the x-direction, the structure was excited along the x-direction only and therefore mode 2 is not visible in FIGS. 8A and 8C. Similarly, the structure was excited along the z-direction only when simulating the bandgap formation for mode 2 and therefore modes 1 and 3 are not visible in FIG. 8B. The reason behind this is to allow a clear observation of the frequency response along each direction and to remove ambiguities between the resonant frequencies of the host structure and the newly created peaks.

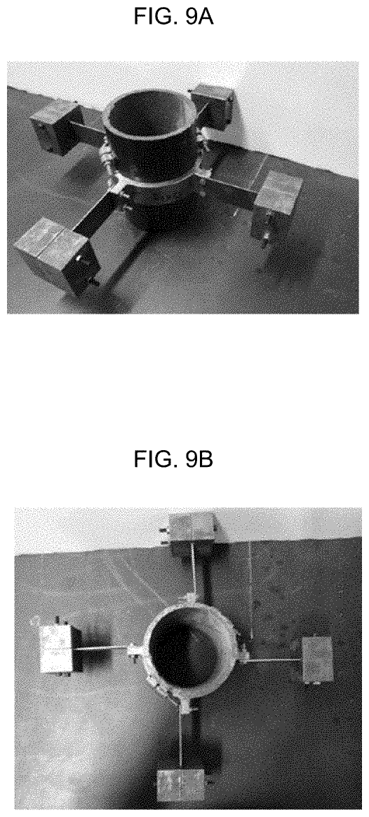

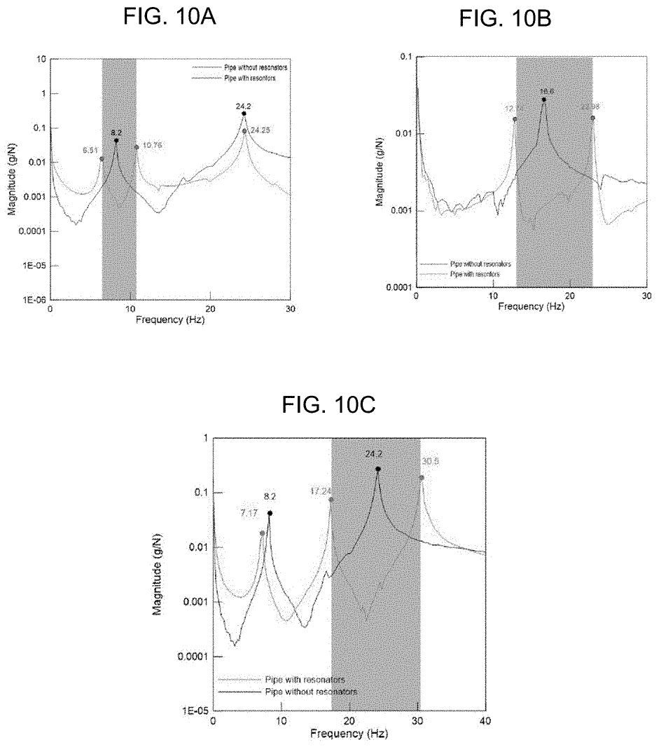

According to an embodiment, a total of eight of the mechanisms (e.g., vibration attenuation device/resonators) were fabricated and attached along the length of the piping system. An example of the fabricated the mechanisms (e.g., vibration attenuation device/resonators) is illustrated in FIGS. 9A and 9B. In this embodiment, single bandgap formation was targeted which means that only 2 beams were attached either along the x or z direction. It is worth mentioning that the mechanism can be used to hold all four beams and create multiple bandgaps in both the x and z directions. The mechanisms (e.g., resonators) are utilized to hold two beams along the x- or z-directions to validate experimentally the bandgap formation for the first three modes of vibration. A total of eight vibration attenuation devices/resonators are attached or embedded along the length of the host structure (e.g., a pipe) at locations that are similar to those in the simulation and which can be seen in FIGS. 7A-7B. Free vibration tests are conducted on the piping metastructure using an impact hammer and accelerations are measured at locations similar to those in the simulation. The piping metastructure is tested in the x-direction only for modes 1 and 3 and in the z-direction only for mode 2. The FRFs of the piping metastructure for the three modes are illustrated in FIGS. 10A-10C. It is evident that the experimental and numerical results are in close agreement since the peaks marked in circles in FIGS. 8A-8C and FIGS. 10A-10C are similar, and thus the vibration attenuation devices/resonators are proven experimentally to be successful in creating bandgaps at the first three modes of vibration.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A vibration attenuation device, comprising:
one or more connectors configured to be attached to a primary structure;
a plurality of beams mounted on the one or more connectors; and
a plurality of weight materials attached to the beams.

2. The vibration attenuation device according to claim 1, wherein the primary structure comprises at least one of a pipe, a rod or a shaft.

3. The vibration attenuation device according to claim 1, wherein the one or more connectors comprises a pair of semi-rings.

4. The vibration attenuation device according to claim 3, wherein the pair of semi-rings are connected to each other through a fastener to form a ring shape.

5. The vibration attenuation device according to claim 1, wherein each of the beams includes a first end attached to the one or more connectors and a second end opposite to the first end.

6. The vibration attenuation device according to claim 5, wherein the plurality of weight materials are attached to the second end of the beams.

7. The vibration attenuation device according to claim 1, wherein the vibration attenuation device comprises two or more beams.

8. The vibration attenuation device according to claim 1, wherein the vibration attenuation device is configured to vibrate at frequencies in approximate to frequencies of the primary structure.

9. The vibration attenuation device according to claim 1, wherein the vibration attenuation device is configured to create a bandgap to the primary structure.

10. The vibration attenuation device according to claim 9, wherein the bandgap is a frequency region, and vibrations are attenuated in the frequency region.

11. A resonator for suppressing vibration in a piping system, comprising:
one or more connectors configured to be attached to a pipe;
a plurality of beams mounted on the one or more connectors; and
a plurality of weight materials attached to the beams.

12. The resonator according to claim 11, wherein the resonator is a three dimensional resonator.

13. The resonator according to claim 11, wherein the resonator has a symmetric shape.

14. The resonator according to claim 11, wherein the one or more connectors comprises a pair of semi-rings.

15. The resonator according to claim 14, wherein the pair of semi-rings are connected to each other through a fastener to form a ring shape.

16. The resonator according to claim 11, wherein the resonator comprises two or more beams.

17. The resonator according to claim 1, wherein the resonator is configured to vibrate at frequencies in approximate to frequencies of the primary structure.

18. The resonator according to claim 1, wherein the resonator is configured to form a bandgap to the pipe, and wherein the bandgap is a frequency region, and vibrations of the pipe are attenuated in the frequency region.
